(19) United States
(12) Patent Application Publication
(10) Pub. No.: US 2018/0369961 A1
(43) Pub. Date: Dec. 27, 2018

(54) TREATMENT OF SOLIDIFIED LAYER

(71) Applicant: Applied Materials, Inc., Santa Clara, CA (US)

(72) Inventors: David Masayuki Ishikawa, Mountain View, CA (US); Paul J. Steffas, Santa Clara, CA (US); Ajey M. Joshi, San Jose, CA (US)

(21) Appl. No.: 15/990,408

(22) Filed: May 25, 2018

Related U.S. Application Data
(60) Provisional application No. 62/524,358, filed on Jun. 23, 2017.

(51) Int. Cl. B23K 26/342; B33Y 10/00; B33Y 40/00; B33Y 30/00; B23K 26/03; B23K 26/06; B23K 26/082; B23K 26/14; B23K 26/70

(52) U.S. Cl. CPC B23K 26/342; B33Y 10/00; B33Y 40/00; B33Y 30/00; B23K 26/032; B23K 31/125; B23K 26/0626; B23K 26/082; B23K 26/14; B23K 26/70; B23K 26/0604

(57) ABSTRACT

An additive manufacturing apparatus and methods relating to forming multiple layers on an object on a support including dispensing a layer of feed material over the support, fusing a portion of the layer of feed material to form a fused portion in the layer, determining to rework a particular region in the fused portion, and reworking the particular region. Reworking the particular region includes establishing a gas flow directed towards the particular region and producing a melt pool having a keyhole within the particular region.

### CROSS-REFERENCE TO RELATED APPLICATIONS

This application claims priority to U.S. Provisional Application Ser. No. 62/524,358, filed on Jun. 23, 2017, the disclosure of which is incorporated by reference.

### TECHNICAL FIELD

This specification relates to treatment of solidified layers in additive manufacturing, also known as 3D printing.

### BACKGROUND

Additive manufacturing (AM), also known as solid freeform fabrication or 3D printing, refers to a manufacturing process where three-dimensional objects are built up from successive dispensing of raw material (e.g., powders, liquids, suspensions, or molten solids) into two-dimensional layers. In contrast, traditional machining techniques involve subtractive processes in which objects are cut out from a stock material (e.g., a block of wood, plastic or metal).

A variety of additive processes can be used in additive manufacturing. Some methods melt or soften material to produce layers, e.g., selective laser melting (SLM) or direct metal laser sintering (DMLS), selective laser sintering (SLS), fused deposition modeling (FDM), while others cure liquid materials using different technologies, e.g., stereolithography (SLA). These processes can differ in the way layers are formed to create the finished objects and in the materials that are compatible for use in the processes.

Conventional systems use an energy source for sintering or melting a powdered material. Once all the selected locations on the first layer are sintered or melted and then re-solidified, a new layer of powdered material is deposited on top of the completed layer, and the process is repeated layer by layer until the desired object is produced.

### SUMMARY

In one aspect, an additive manufacturing process including forming multiple successive layers on an object on a support. Forming at least some of the multiple layers includes dispensing a layer of feed material (e.g., metal powder) over the support, and fusing a portion of the layer of feed material to form a fused portion in the layer. For at least some of the multiple layers, a particular region of the fused portion is determined to require rework, where the rework of the particular region includes establishing a gas flow directed towards the particular region and producing a melt pool having a keyhole within the particular region.

These and other embodiments can each optionally include one or more of the following features. In some implementations, a determination to rework the particular region includes performing a metrological scan on the build layer (e.g., a camera, optical microscope, etc.). The metrological scan may determine that the particular region includes a threshold of defects, where an excess of defects above the threshold of defects merits a rework process.

In some implementations, a determination to rework the particular region is based in part on parameters for forming the fused portion of the layer on the object, for example, a laser power and/or scan velocity used during the fusing process.

The parameters for forming the fused portion of the layer may also include a location of the fused portion of the layer on the object relative to other fused portions of the layer on the object. For example, a fused portion within an interior of the layer on the object versus a fused portion along an edge or contour of the layer on the object.

In some implementations, producing a melt pool includes directing a beam of a rework laser to trace a path (e.g., in a scan pattern) that covers the particular region. A direction of the gas flow may also trace the path of the rework laser as it covers the particular region.

In some implementations, the object and any formed layers from the multiple layers on the object are pre-heated prior to reworking the particular region (e.g., producing a meltpool in the particular region).

In some implementations, the keyhole extends from a portion of a top-most layer formed on the object through fused portions of one or more additional layers formed on the object.

In another aspect, a system includes a support having a surface to support an object being manufactured, a feed material dispenser to deliver multiple successive layers of feed material (e.g., metallic powder) over the support, and one or more energy sources. The one or more energy sources are configured to fuse at least a portion of an outermost layer of feed material on the support to form a fused portion. The one or more energy sources are also configured to rework a particular region in the fused portion by producing a melt pool having a keyhole within the particular region.

In some implementations, the energy source is a common light source (e.g., a laser) and a common mirror scanner (e.g., galvanometer) to generate and direct a light beam onto the feed material, respectively. The energy source can both fuse at least the portion of the outermost layer and produce a melt pool within the outermost layer. The energy source may include two light sources (e.g., two laser, or one laser and one IR lamp) generating two light beams, where the light beam of one light source fuses the portion of the outermost layer and the second light beam of the second light source produces the melt pool. Additionally, the energy source can include two mirror scanners (e.g., a galvanometer and a hexagonal rotating mirror), where the first mirror scanner controls a position of the first light beam and the second mirror scanner controls a position of the second light beam.

In some implementations, the system includes a gas source (e.g., an argon gas source) and a nozzle coupled to the gas source, where the gas source and nozzle are configured to establish a gas flow directed towards the particular region. The gas source and nozzle can also be configured to direct a gas flow along a path (e.g., a path of a rework laser).

In some implementations, the system includes a controller that is configured to determine whether to rework a particular region of a fused layer. The controller may use information relayed by one or more metrological apparatuses (e.g., a camera, XPS, SEM, optical microscope or the like) that views at least the fused portion of the outermost layer of feed material. The controller may determine a presence of defects based on an image or other collected data from the metrological apparatus and determine to rework the particular region based on the presence of defects (e.g., an amount of defects or density of defects above a threshold) in the particular region.

Advantages of the foregoing may include, but are not limited to, the following.

An additive manufacturing system with an in situ rework system may increase yield for parts that would otherwise be scrapped due to defects found during and/or after a build on the part. Surface irregularities and defects found embedded in a layer (e.g., defective microstructures, voids, etc.) of a part may be reworked, improving part quality and lifetime. A rework process may further be used to adjust grain properties, for example, to grow grain size in the fused layers.

A keyhole is a three-dimensional depression on the surface of the melt pool caused by the thermal interaction of the laser with material in the molten material and vapor phases. Keyholes typically form in melt pools produced using high laser power and low laser scan speed. The keyhole can be a transitory phenomenon; once the laser power is removed the molten material will refill the keyhole. Conventional additive manufacturing processes select laser power and scan speed to minimize or prevent keyhole formation due to the risk that vapor bubbles become trapped pores upon keyhole collapse.

Utilizing a laser process that purposefully induces a deep keyhole in the melt pool may enable deep penetration melting, such that a re-melt process may be used to melt through multiple layers and may reduce porosity between the multiple layers, in particular along an edge of a contour where surface and near-surface pore defects are known to adversely affect part fatigue life. Keyhole melting may also be useful for producing fully-fused microstructures that extend in the Z-axis through multiple layers. For example, a lattice structure throughout the interior hatch region of the part may be used to strengthen the bulk volume of the part. In this way, part features fabricated using a keyhole scan strategy can meet or exceed quality requirements without hatched areas being fully fused or completely pore free.

In addition, scanning at elevated temperatures may facilitate keyhole stability. A gas flow directed towards the melt pool may reduce vortexes and oscillations of the melt pool, and assist in reducing defects from forming due to keyholes in a post-process melt pool as it cools.

The details of one or more implementations of the subject matter described in this specification are set forth in the accompanying drawings and the description below. Other potential features, aspects, and advantages will become apparent from the description, the drawings, and the claims.

### BRIEF DESCRIPTION OF THE DRAWINGS

FIGS. 1A, 1B and 1C are schematic side views of an example of an additive manufacturing apparatus including a rework subsystem.

FIG. 2 is a flow diagram of an example process for reworking a sample in an additive manufacturing apparatus.

FIG. 3 is a schematic side view of an example of a melt pool with a keyhole.

FIG. 4 is a schematic of example fused portions of an object and a rework region.

Like reference numbers and designations in the various drawings indicate like elements.

### DETAILED DESCRIPTION

A limiting factor to component yield includes irregularities and defects within layers such as pores, pits or surface peaks/valleys due to hatch scanning, as well as porosity between layers. In general, parts are scrapped after a build is complete or mid-layer if a layer is found to be defective due to a lack of laser-based rework options. An additive manufacturing system configured to provide in-situ reworking of a layer before it is covered by another layer could provide significantly increased yield. Additionally, known commercially available additive manufacturing systems are not configured for performing in situ rework by identifying potential defects and correcting the defects using one or more re-melting processes.

In many additive manufacturing processes, keyholes are generally avoided by reducing laser power and increasing laser velocity in order to prevent the defects (e.g., porosity) that can form from trapped gases when a melt pool collapses into the keyhole during the cooling process.

Keyholes can be used to improve component performance and yield by enabling deep penetration melting during rework processes. Stabilizing the keyhole through gas flow provided during the rework process can reduce the formation of defects (e.g., porosity) that result from melt pool recirculation and keyhole oscillation and collapse. Additionally, alternate layers or select regions of a single layer can treated as a proactive method to strengthen or otherwise ensure critical regions of the part are defect free.

### Example Additive Manufacturing Apparatuses

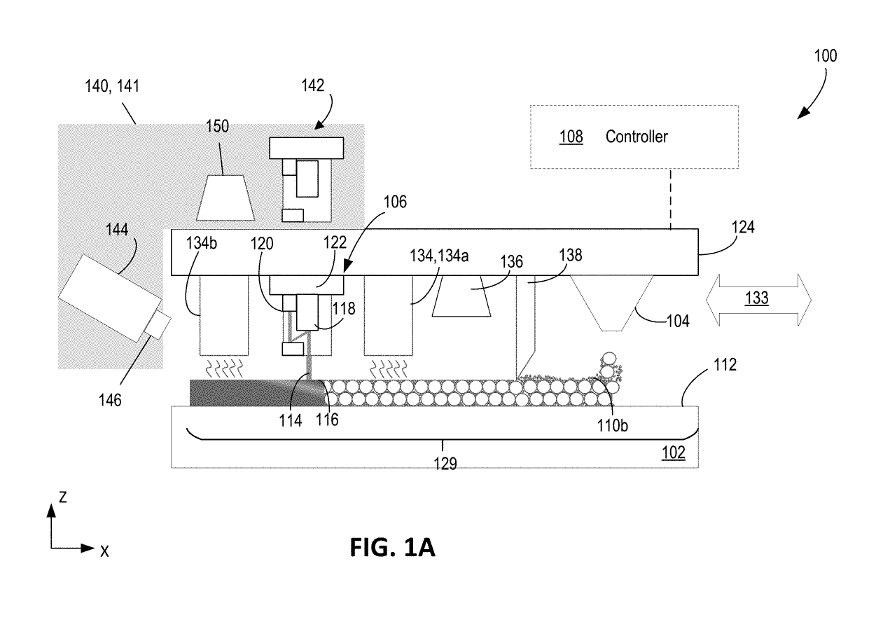

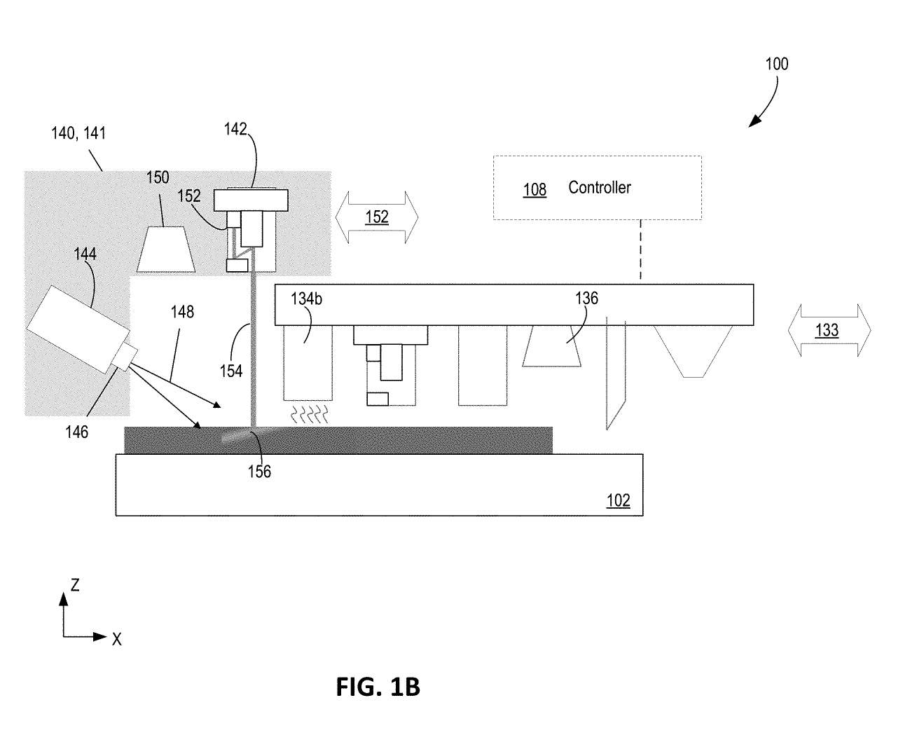

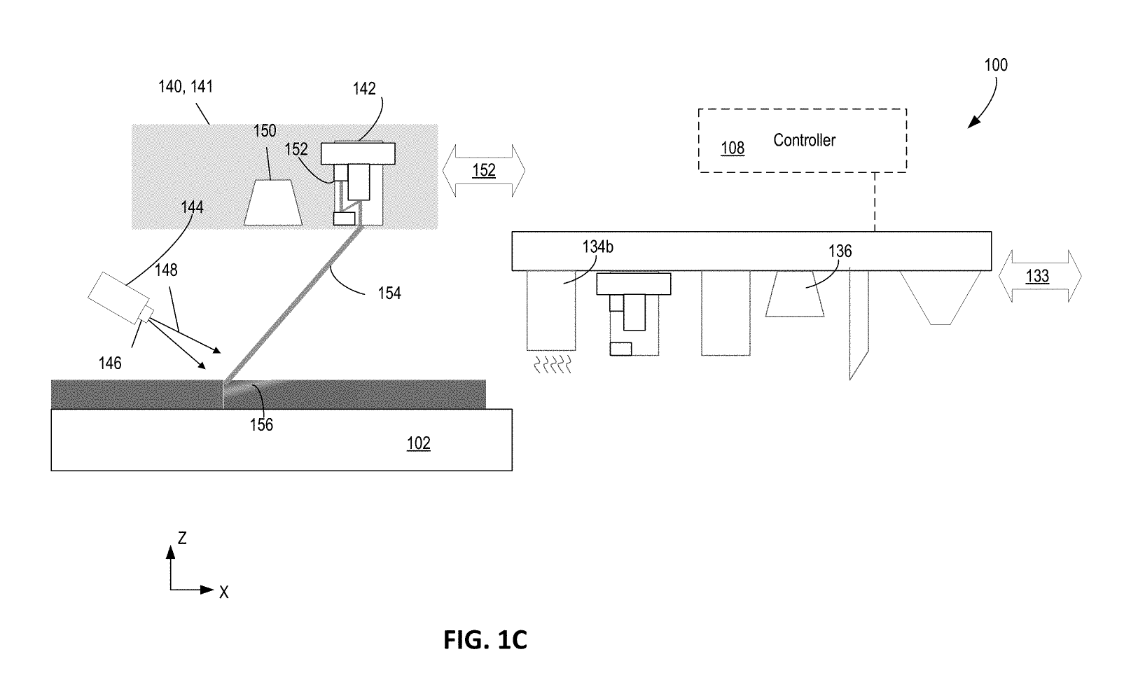

Referring to FIGS. 1A and 1B, an example of an additive manufacturing apparatus 100 includes a platform 102, a dispenser 104, an energy delivery system 106, and a controller 108. During an operation to form an object, the dispenser 104 dispenses successive layers of feed material 110 on a top surface 112 of the platform 102. The energy delivery system 106 emits a beam to deliver energy to an uppermost layer 116 of the layers of feed material 110, thereby causing the feed material 110 to be fused, for example, in a desired pattern to form the object. The controller 108 operates the dispenser 104 and the energy delivery system 106 to control dispensing of the feed material 110 and to control delivery of the energy to the layers of feed material 110. The successive delivery of feed material and fusing of feed material in each of the successively delivered layers result in formation of the object.

In some implementations, the energy delivery system 106 includes a light source 120 to emit a light beam 114. The energy delivery system 106 further includes a reflective member 118 (e.g., a common mirror scanner) that is movable and that redirects the light beam 114 toward the outermost layer 116. As the light beam 114 sweeps along a path on the layer 116, the light beam 114 is modulated, e.g., by causing the light source 120 to turn the light beam 114 on and off, in order to deliver energy to selected regions of the layers of feed material 110 and fuse the material in the selected regions to form the object in accordance to the desired pattern.

A variety of systems can be used to scan the light beam 114 along the path on the layer 116. For example, scanning along the width of the platform (into and out of the page in FIG. 1) could be provided by a first mirror galvanometer scanner, and scanning along the length of the platform (left-right in FIG. 1) could be provided by a second mirror galvanometer scanner, or by relative motion between the platform 102 and the light source 120, e.g., by an actuator that moves a support 122 on which the light source 120 is mounted. As another example, scanning along the width of the platform could be provided by a rotating polygonal mirror scanner, and scanning along the length of the platform (left-right in FIG. 1) could be provided by a mirror galvanometer scanner, or by relative motion between the platform 102 and the light source 120, e.g., by an actuator that moves a support 122 on which the light source 120 is mounted. In this case, the reflective member 118 is rotatable to sweep the light beam 114 along a path, e.g., a linear path, on the uppermost layer 116. In conjunction with relative motion of the energy delivery system 106 and the platform 102, or deflection of the light beam 114 by another reflector, e.g., a galvanometer-driven mirror, a sequence of sweeps along the path by the light beam 114 can create a raster scan of the light beam 114 across the uppermost layer 116.

In some implementations, the energy delivery system 106 is mounted to a support 122 that supports the energy delivery system 106 above the platform 102. In some cases, the support 122 (and the energy delivery system 106 mounted on the support 122) is rotatable relative to the platform 102. In some implementations, the support 122 is mounted to another support 124 arranged above the platform 102. The support 124 can be a gantry that supports the energy delivery and dispensing systems of the additive manufacturing apparatus 100 above the platform 102.

In some cases, the support 122 is rotatably mounted on the support 124. The reflective member 118 is rotated when the support 122 is rotated, e.g., relative to the support 124, thus reorienting the path of the light beam 114 on the uppermost layer 116. For example, the energy delivery system 106 can be rotatable about an axis extending vertically away from the platform 102, e.g., an axis parallel to the Z-axis, between the Z-axis and the X-axis, and/or between the Z-axis and the Y-axis. Such rotation can change the azimuthal direction of the path of the light beam 114 along the X-Y plane, i.e., across the uppermost layer 116 of feed material.

In some implementations, the support 124 is repositionable along one or more horizontal directions relative to platform 102 by the controller 108. For example, the platform 124 may be positioned along an x-axis, and moved in a forward and/or backward direction 133. In some implementations, the platform 124 may be moved along a forward and/or backward direction 133 repeatedly during the process of an additive manufacturing process, including one or more rework processes to an object on the platform 102.

In some implementations, the additive manufacturing apparatus 100 includes a bulk energy delivery system 134. For example, in contrast to delivery of energy by the energy delivery system 106 along a path on the uppermost layer 116 of feed material, the bulk energy delivery system 134 delivers energy to a predefined area of the uppermost layer 116. The bulk energy delivery system 134 can include a heating lamp that, when activated, delivers the energy to the predefined area within the uppermost layer 116 of feed material 110.

Assuming the energy delivery system 106 moves relative to the platform 102, the bulk energy delivery system 134 is arranged ahead of or behind the energy delivery system 106, e.g., relative to the forward direction 133. The bulk energy delivery system 134 can be arranged ahead of the energy delivery system 106, for example, to deliver energy immediately after the feed material 110 is dispensed by the dispenser 104. This initial delivery of energy by the bulk energy delivery system 134 can stabilize the feed material 110 prior to delivery of energy by the energy delivery system 106 to fuse the feed material 110 to form the object.

Alternatively, the bulk energy delivery system 134 can be arranged behind the energy delivery system 106, for example, to deliver energy immediately after the energy delivery system 106 delivers energy to the feed material 110. This subsequent delivery of energy by the bulk energy delivery system 134 can control the cool-down temperature profile of the feed material, thus providing improved uniformity of curing. In some cases, the bulk energy delivery system 134 is a first of multiple bulk energy delivery systems 134a, 134b, with the bulk energy delivery system 134a being arranged behind the energy delivery system 106 and the bulk energy delivery system 134b being arranged ahead of the energy delivery system 106.

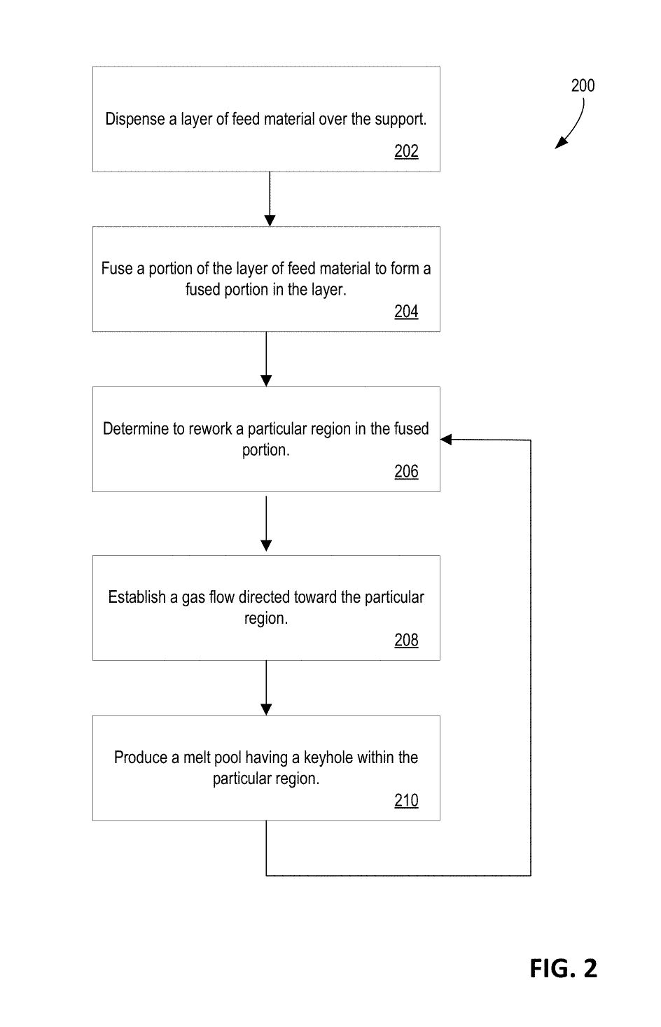

Optionally, the apparatus 100 includes a sensing system 136 to detect properties, e.g., temperature, density, and material, of the layer 106 as well as powder dispensed by the dispenser 104. The controller 108 can coordinate the operations of the energy delivery system 106, the dispenser 104, and, if present, any other systems of the apparatus 100. In some cases, the controller 108 can receive user input signal on a user interface of the apparatus or sensing signals from the sensing system 136 of the apparatus 100, and control the energy delivery system 106 and the dispenser 104 based on these signals. In some implementations, multiple sensing systems 136a, 136b (not shown) may be used, where the sensing systems 136a, 136b may characterize different aspects of the layer properties. Additionally, sensing system 136 may characterize the process by which layers are fused. Controller 108 can receive the characterized process from sensing system 136 and determine to rework a portion or all of a fused layer during a rework process, as described herein in more detail with reference to FIG. 2.

Optionally, the apparatus 100 can also include a spreader 138, e.g., a roller or blade, that cooperates with first the dispenser 104 to compact and/or spread feed material 110 dispensed by the dispenser 104. The spreader 138 can provide the layer with a substantially uniform thickness. In some cases, the spreader 138 can press on the layer of feed material 110 to compact the feed material 110. The spreader 138 can be supported by the support 124.

In some implementations, the dispenser 104 includes multiple dispensers, and the feed material 110 includes multiple types of feed material, where a first dispenser 104a dispenses a first feed material, while a second dispenser dispenses a second feed material. If present, the second dispenser enables delivery of a second feed material having properties that differ from those of the first feed material. For example, the first feed material and the second feed material can differ in material composition or average particle size.

In some cases, the spreader 138 includes multiple spreaders, with the first spreader being operable with the first dispenser to spread and compact the first feed material second spreader being operable with the second dispenser to spread and compact the second feed material.

The additive manufacturing system 100 also includes a rework subsystem 140. Rework subsystem 140 can include rework energy delivery system 142 and a gas source 144. The gas source 144 may include nozzle 146 which can be used to direct a gas jet 148 (shown in FIG. 1B) towards the uppermost surface 116. Additionally, rework subsystem 140 may include a sensing system 150 (e.g., a camera or an optical microscope).

The rework subsystem 140 may be mounted on support 124, or may be mounted separately on a rework support 141; the support 124 is movable independently of support 141. Rework support 141 may be positionable in a forward and/or backward direction 152 along an x-axis. Alternatively, rework support 141 may be stationary relative to the support 102 within additive manufacturing system 100.

In one example, rework subsystem 140 may be positioned above and/or adjacent to the support 124, as seen in FIGS. 1A and 1B. When the rework subsystem 140 is not engaged (e.g., the rework energy delivery system 142 is inactive), the support 124 is in a first position along direction 133 on the x-axis, for example, as shown in FIG. 1A. When the rework subsystem 140 is engaged (e.g., the rework energy delivery system 142 is active), the support 124 is in a second position, forward position along direction 133 on the x-axis, for example, as shown in FIG. 1B.

In some implementations, support 124 is moved along a forward position 133 to a third position, as seen in FIG. 1C. When support 124 is in the third position shown in FIG. 1C, the rework subsystem 140 may be positioned in an engaged position and the rework energy delivery system 142 is engaged. The light beam 152 may be scanned such that light beam 154 can be directed across a particular region to produce melt pool 156.

In some implementations, the energy delivery system 142 may be configured similarly to energy delivery system 106 and includes a light source 152 (e.g., a laser) to emit a light beam 154.

In some implementations, the gas source 144 includes a gas delivery system (not shown) and a nozzle 145 coupled to the gas source 144. The nozzle 146 may be configured to produce a gas jet 148 directed towards a particular region on the fused layer, and more specifically directed towards a location of the uppermost layer 116 that is being reworked. The gas source 144 may include one or more inert gases (e.g., argon, nitrogen, helium), or a mixture of inert gases (e.g., argon mixed with nitrogen).

Additionally, the gas source 144 may include a flowmeter that can be used to control a velocity of the gas jet 148 (e.g., 100 meters/sec). A position of the gas jet 148 as it impinges on a surface of the uppermost fused layer 116 may be directed by the nozzle 146 and directed by the controller 108. In some implementations, the gas source 144 is adjustable to trace a path within a particular region along the uppermost surface 116 of the fused portion. In some implementations, the flow (e.g., velocity) of the gas jet 145, gas jet beam profile, and location of the gas jet 148 is configured and adjustable by controller 108. In some implementations, the gas jet 148 can follow the same path as the light beam 154. In particular, the gas jet 148 can be controlled such that the region of the uppermost surface onto which the gas flows is the same as the region being treated by the light beam 154, such that the gas jet 148 may be used to stabilize the melt pool 156 as the melt pool traverses the particular region. In some implementations, the gas source 144 is used to direct vapor and spatter emitted by the melt pool toward the inert environment exhaust (not shown) or toward areas of the top surface 112 beyond the perimeter of the fused layer 116

In some implementations, the sensing system 150 may be configured to detect properties, e.g., temperature, density, and material, of the uppermost layer 116 (or other previously fused layers, not shown). In some cases, the controller 108 can receive user input signal on a user interface of the apparatus or sensing signals from the sensing system 150 of the apparatus 100, and control the energy delivery system 142. In some implementations, multiple sensing systems can be used, where the sensing systems may characterize different aspects of the layer properties. For example, the sensing system 150 can include an optical microscope or a visual or infrared camera configured to view at least a fused portion of the outermost layer 116 of feed material and to detect irregularities as the melt pool cools. An optical emission spectrophotometer can be used to monitor the vapor plume temperature and composition as a surrogate method for determining keyhole stability that may be visually obscured by the plume itself. Additionally, two-dimensional or three-dimensional laser profilometers can be used to detect pits or surface peaks/valleys in layer 110. In another example, sensing system 150 may include a pyrometer to detect irregularities in the melt pool during fusion of layer 110.

### Rework Process of a Region of a Fused Portion of a Layer

FIG. 2 is a flow diagram of an example process flow 200 for forming multiple successive layers on an object on a support. A layer of feed material is dispensed by one or more material dispensers 104 over the support 102 (202). As described with reference to FIGS. 1A and 1B, feed material may include one or more different types of feed material (e.g., different sized grains or different compositions). Dispensing the material may include one or more material dispensers 104 and one or more spreader 138 mechanisms for distributing the feed material over the support. A controller 108 may be used, for example, to determine relative amounts of feed material, locations to dispense the one or more feed materials, operating of the spreader 138, or other feed material dispensing processes.

In some implementations, the dispensing of feed material may be monitored or characterized by a sensing system 136 where the sensing system (e.g., a camera) may record a distribution of feed material over the support, and can relay the information to a controller 108, which, in turn, may adjust one or more parameters for the material dispenser 104 and/or spreader 138 accordingly.

After feed material has been dispensed, a portion of the layer of feed material is fused to form a fused portion in the layer (204). The fusing of the portion of the layer of feed material may include a pre-heating step by a bulk energy delivery system 134 (e.g., an IR lamp), a fusion step by an energy delivery system 106 (e.g., a laser), and a post-heating step by a bulk energy delivery system 134 (e.g., an IR lamp). In some implementations, the energy delivery system 106 provides energy into the feed material to generate a melt pool, where the melt pool characteristics (e.g., spot size, depth, etc.) are controlled in part by adjusting the laser power and scan velocity of the energy delivery system 106. Typical laser power and scan speeds optimized to avoid or minimize keyhole formation may be used in a majority of the layers and re-melt processing involving sustained large keyholes reserved for critical layers or regions of critical layers where minimum defects are required to meet part yield requirements.

Once a portion of the layer of feed material is fused, a particular region in the fused portion may be determined to need rework of the particular region (206). A controller 108 may determine to rework the particular region based in part on a performed metrological scan on the fused portion in the layer. For example, a metrological scan using a sensing systems 136, 150 can include a scan using an optical microscope or another spectroscopy tool, and image data from the sensing systems 136, 150 can be processed to detect defects on the surface or within a fused portion of a layer.

In some implementations, determining to rework a particular region of a fused portion includes determining that the particular region has a threshold of defects. For example, the controller 108 can determine if a particular region has a density of defects greater than the threshold; if the density of defects is greater than the threshold the controller can cause the system to rework the particular region. A threshold of defects may differ depending on a type or location of defects, for example, porosity between layers may have a first threshold and surface roughness defects may have a second threshold. Additionally, defects along contours may have a lower threshold for rework than defects in an interior portion of the fused portion.

In some implementations, determining to rework a particular region of a fused portion may be based in part on a set of parameters utilized for forming the layer on the object. For example, a particular region fused under a set of Power-Velocity (P-V) conditions defining laser power and scan velocity, where the laser power and scan velocity are parameters utilized for forming the layer on the object. For example, P-V conditions (e.g., a PV process map) including low laser power and fast scan velocity may have need for rework to ensure fusion between the particular region and one or more previously fused layers.

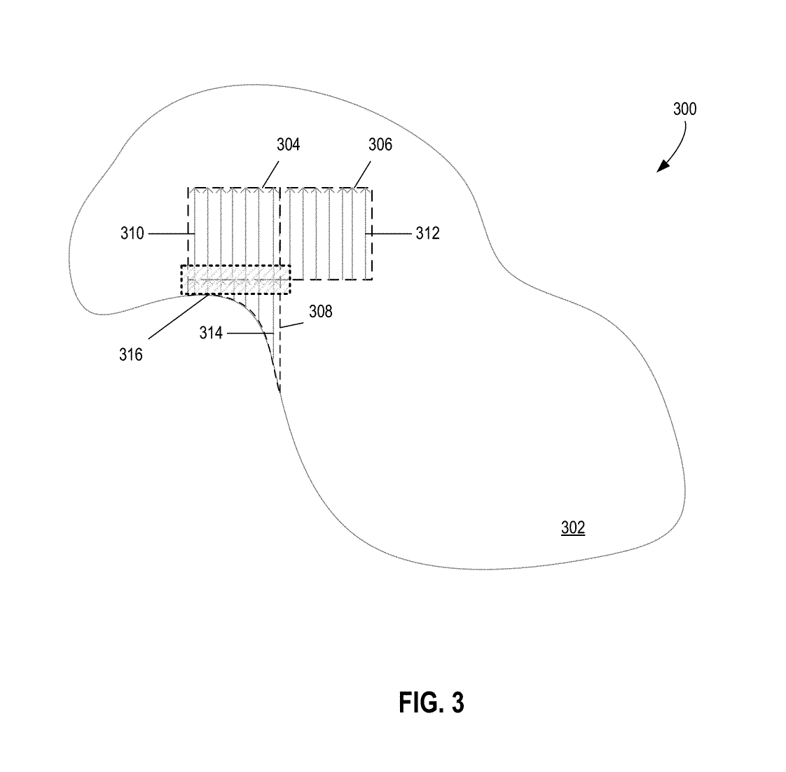

Rework may also be determined for a particular region depending on parameters defining a location of the particular region in the fused portion relative to other fused portions on the object, as discussed in further detail with reference to FIG. 3. As one example, regions where a scan pattern for an interior region of the object 302 intersect a contour of the object that is fused by tracing of the contour with the light beam might need rework. As another example, for an object 302 having fused regions 304, 306, and 308, where regions 304 and 306 and respective hatch patterns 310 and 312 are in the interior of the object 302, and region 308 with hatch pattern 314 at the contour of object 302. The particular region 316 may require rework due to a difference between fusion conditions (e.g., laser power and/or scan velocity) that may be used to fuse the interior region 304 and the contour region 308. In some implementations, rework for a particular region is determined after a number of layers are fused, such that rework is performed between multiple fused layers, for example, to align grain boundaries between fused layers.

Once a particular region is determined to require rework, a gas flow directed towards the particular region is established (208). A gas flow supplied by gas source 144 may include one or more inert gases (e.g., argon, nitrogen, helium). As described with reference to FIGS. 1A and 1B, the gas source 144 can be configured to deliver a gas jet 148 of a set velocity and directed towards the particular region that is being reworked. In some implementations, the gas flow provided by the gas source 144 is adjustable such that the gas flow traces a path over the particular region. In some implementations, nozzle 146 has an opening diameter of 1-5 mm, e.g., 2 mm, depending on desired spot size. The gas jet 148 may have a velocity between 50-150 meters per second, for an additive manufacturing system 100 operating under vacuum pressures of 10̂-6 to 10̂-3 Torr. The nozzle may be shaped to provide the gas jet with a circular or linear beam profile. The nozzle may provide a spot size at the surface that is about the same size as a fused island or strip formed by a single scan by the light beam; this is usually less than 10 millimeters wide.

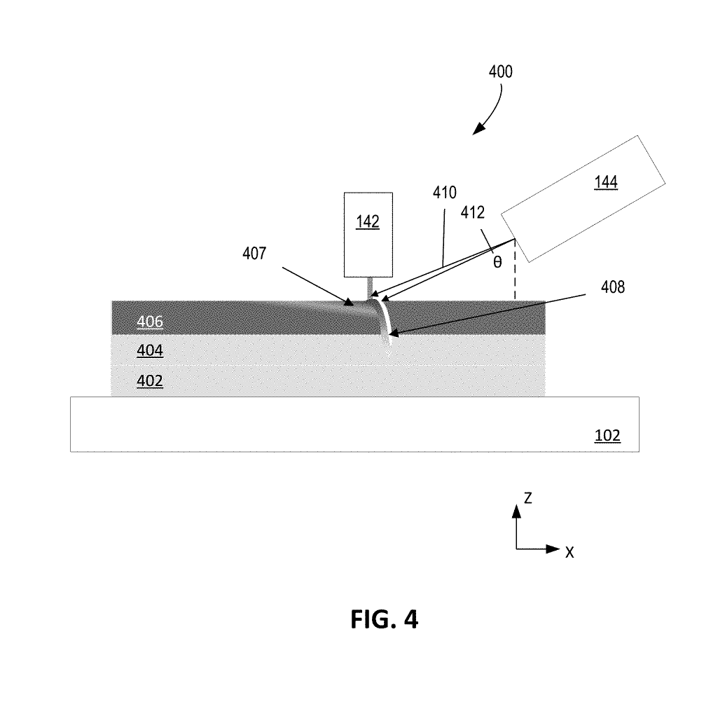

A melt pool 156 having a keyhole (see FIG. 4) is produced within the particular region (210). The melt pool 156 may be produced by directed a beam 154 from light source 152 (e.g., a rework laser) of energy delivery system 142 towards the particular region using a set of conditions including laser power and scan velocity. Above a threshold of energy density directed towards the particular region, a keyhole forms within the melt pool due to an enhancement of metal vaporization. A keyhole is a hole in the melt pool that is maintained during the melting process by the release of vapor during melting of the metal, e.g., vapor resulting from trapped impurities that are released and vaporized during melting of the metal or vaporization of the metal itself. The keyhole can be considered a vapor capillary formed within the melt pool; the keyhole will move as the melt pool moves due to scanning of the light beam. The threshold of energy required to sustain a keyhole depends in part on material properties of the fused layer. The energy delivery system 142 may direct a beam of a light source (e.g., rework laser) to trace a path that covers the particular region, such that the melt pool 156 having a keyhole traces the path covering the particular region.

In some implementations, the melt pool 156 is produced after the gas flow is established and directed towards the particular region. The melt pool 156 may also be produced simultaneously with establishing the gas flow, or prior to establishing the gas flow in the particular region. In some implementations, the gas flow onto the layer traces a path of the melt pool 156 produced by the scanning the light source 152 of the energy delivery system 142 and covers the particular region.

In some implementations a pre-heat process is performed prior to producing the melt pool using one or more bulk energy delivery systems 134. The pre-heat process may include pre-heating the object including any formed layers that were fused prior to the reworking process of the particular region.

The melt pool including a keyhole may be produced by an energy density focused on a spot size within the particular region by energy delivery system 142. An amount of energy (e.g., laser power and scan velocity) produced by the energy delivery system 142 may depend in part on the type of rework process, a dimension or location of the particular region, the material of the fused region, and the like. In some implementations, a spot size of a light source (e.g., rework laser) 148 of the energy delivery system 142 is comparable or a same size as the melt pool produced by the process to fused the layer.

In some implementations, a rework process may involve forming a keyhole in a melt pool that penetrates multiple layers on an object. The keyhole may extend from a fused portion of a top-most layer formed on the object through fused portions of one or more additional layers formed on the object. FIG. 4 is a schematic of an example 400 of reworking a fused portion of an object within a rework region using a keyhole. Platform 102 including three fused layers, 402, 404, and 406, where each of the layers has been previously fused, for example, using the process described herein with reference to FIG. 2. A melt pool 407 including a keyhole 408 is produced using energy delivery system 142 (e.g., a rework laser with a galvanometer system and/or other mirror positioning system). The keyhole 408 is shown here to penetrate layers 406 and 404. The keyhole 408 may further penetrate through additional layers, for example, layer 402. In some implementations, multiple layer penetration is used to correct for poor quality hatch work and fused layers, to add strategic structural stability, and/or to regrow grains across multiple layers (e.g., layers 406 and 404), for example, as discussed with reference to FIG. 3.

In some implementations, a gas flow from gas source 144 is established during the rework process (e.g., prior to or after the melt pool is produced). A gas jet 410 of the gas source 144 may be angled with respect to normal incidence of the platform 102. An angle θ 412 of the gas jet 410 may range between 45 and 90 degrees with the flow and angle optimized to effectively flattens the melt pool surface and thus to stabilize the keyhole. In some implementations, the angle 412 is 45° degrees. A velocity and angle of the gas jet 410 from gas source 144 may be selected, in part, to reduce vortexes and oscillations of the melt pool 407 and/or keyhole 138. Furthermore, the velocity and angle of gas jet 428 from gas source 144 may be selected to prevent the melt pool 407 from collapsing into the keyhole 138 and to give sufficient time for trapped gas pockets and/or bubbles to rise from within the keyhole 138 to the surface of the top-most layer (e.g., layer 406) before the metal of the melt pool 407 cools and solidifies. Additionally, the velocity and angle of the gas jet 428 from gas source 144 may also be selected to stabilize a temperature profile of the melt pool 407.

### Alternative Implementations

Controllers and computing devices can implement these operations and other processes and operations described herein. As described above, the controller 108 of the apparatus 100 can include one or more processing devices connected to the various components, systems, and subsystems of the apparatus 100. The controller 108 can coordinate the operation and cause the apparatus 100 to carry out the various functional operations or sequence of steps described above.

The controller 108 and other computing devices part of systems described herein can be implemented in digital electronic circuitry, or in computer software, firmware, or hardware. For example, the controller can include a processor to execute a computer program as stored in a computer program product, e.g., in a non-transitory machine readable storage medium. Such a computer program (also known as a program, software, software application, or code) can be written in any form of programming language, including compiled or interpreted languages, and it can be deployed in any form, including as a standalone program or as a module, component, subroutine, or other unit suitable for use in a computing environment.

The controller 108 and other computing devices part of systems described can include non-transitory computer readable medium to store a data object, e.g., a computer aided design (CAD)-compatible file that identifies the pattern in which the feed material should be deposited for each layer. For example, the data object could be a STL-formatted file, a 3D Manufacturing Format (3MF) file, or an Additive Manufacturing File Format (AMF) file. For example, the controller could receive the data object from a remote computer. A processor in the controller 108, e.g., as controlled by firmware or software, can interpret the data object received from the computer to generate the set of signals necessary to control the components of the apparatus 100 to fuse the specified pattern for each layer.

While this document contains many specific implementation details, these should not be construed as limitations on the scope of any inventions or of what may be claimed, but rather as descriptions of features specific to particular embodiments of particular inventions. Certain features that are described in this document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The processing conditions for additive manufacturing of metals and ceramics are significantly different than those for plastics. For example, in general, metals and ceramics require significantly higher processing temperatures. Thus 3D printing techniques for plastic may not be applicable to metal or ceramic processing and equipment may not be equivalent. However, some techniques described here could be applicable to polymer powders, e.g. nylon, ABS, polyetheretherketone (PEEK), polyetherketoneketone (PEKK) and polystyrene.

A number of implementations have been described. Nevertheless, it will be understood that various modifications may be made. For example,
Instead of a light beam, another kind of energy beam, e.g., an electron-beam, can be used to fuse the feed material. In this case an electron beam source and electron beam can be substituted, e.g., for the laser and laser beam.
The energy delivery system 106 can be advanced incrementally along the Y-axis so that the light beam can be delivered across an entire length of the platform 102. In some cases, the energy delivery system 106 is advanced an increment at the end of a single path across the platform 102. The light source 120 can be controlled such that the light beam 114 is not emitted when the energy delivery system 106 is being advanced, for example, as the predicted location of the light beam 114 incident on the reflective member 118 moves from one facet to another facet.

Accordingly, other implementations are within the scope of the claims.

What is claimed is:

1. An additive manufacturing process comprising:
forming a plurality of successive layers on an object on a support, wherein forming at least some layers from the plurality of layers includes
dispensing a layer of feed material over the support,
fusing a portion of the layer of feed material to form a fused portion in the layer,
determining to rework a particular region in the fused portion, and
reworking the particular region, the reworking including
establishing a gas flow directed towards the particular region, and
producing a melt pool having a keyhole within the particular region.

2. The additive manufacturing process of claim 1, wherein determining to rework the particular region comprises performing a metrological scan on the build layer.

3. The additive manufacturing process of claim 1, wherein determining to rework the particular region further comprises determining that the particular region includes a threshold of defects.

4. The additive manufacturing process of claim 1, wherein determining to rework the particular region is based in part on parameters for forming the layer on the object.

5. The additive manufacturing process of claim 4, wherein parameters for forming the layer include laser power and scan velocity.

6. The additive manufacturing process of claim 4, wherein parameters for forming the layer include a location of the fused portion of the layer on the object relative to other fused portions of the layer on the object.

7. The additive manufacturing process of claim 1, wherein producing the melt pool comprises directing a beam of a rework laser to trace a path that covers the particular region.

8. The additive manufacturing process of claim 6, wherein a direction of the gas flow traces the path of the rework laser that covers the particular region.

9. The additive manufacturing process of claim 1, further comprising pre-heating the object including any formed layers from the plurality of layers prior to reworking the particular region.

10. The additive manufacturing process of claim 1, wherein the keyhole extends from a fused portion of a top-most layer formed on the object through fused portions of one or more additional layers formed on the object.

11. An additive manufacturing system, comprising:
a support having a surface to support an object being manufactured;
a feed material dispenser to deliver a plurality of successive layers of feed material over the support;
one or more energy sources configured to
fuse at least a portion of an outermost layer of feed material to form a fused portion, and
rework a particular region in the fused portion by producing a melt pool having a keyhole within the particular region.

12. The system of claim 11, wherein the energy source comprises a common light source to generate a light beam and a common mirror scanner to direct the light beam onto feed material to both fuse at least the portion of the outermost layer and produce a melt pool.

13. The system of claim 11, wherein the energy source comprises a first light source to generate a first light beam fuse to fuse the portion of the outermost layer and a second light source to generate a second light beam to produce the melt pool.

14. The system of claim 13, wherein the energy source comprises a first mirror scanner to control positioning of the first light beam and a second mirror scanner to control positioning of the second light beam.

15. The system of claim 11, comprising a gas source and a nozzle coupled to the gas source and configured to establish a gas flow directed towards the particular region.

16. The system of claim 11, wherein the gas source is an argon gas source.

17. The system of claim 11, comprising a controller configured to determine whether to rework the particular region.

18. The system of claim 17, comprising a camera, optical emission spectrophotometer, or laser profilometer configured to view at least a fused portion of the outermost layer of feed material.

19. The system of claim 18, wherein the controller is configured to determine presence of defects based on data from the camera, optical emission spectrophotometer, or laser profilometer and to determine whether to rework the particular region based on presence of defects in the particular region.

20. The system of claim 17, comprising a camera, optical emission spectrophotometer, or laser profilometer configured to view a fused portion and/or vapor plume, and wherein the controller is configured to determine presence of defects based on an image from the camera, an emission spectrum and intensity from the optical emission spectrophotometer, or topology data from the profilometer, and to determine whether to rework the particular region based on the presence of defects in the particular region.
